(19) United States
(12) Patent Application Publication
(10) Pub. No.: US 2017/0121582 A1
(43) Pub. Date: May 4, 2017

(54) HIGHLY HEAT CONDUCTIVE BORON NITRIDE INSULATION MATERIAL AND PREPARATION METHOD THEREFOR

(71) Applicant: LONGPONT CO., LTD, Guangdong (CN)

(72) Inventors: Donghua XIAO, Guangdong (CN); Demiao LIN, Guangdong (CN); Shiyi TAO, Guangdong (CN)

(21) Appl. No.: 15/317,099

(22) PCT Filed: Jan. 20, 2015
(86) PCT No.: PCT/CN2015/000032

§ 371 Date: Dec. 7, 2016

(30) Foreign Application Priority Data
Jun. 18, 2014 (CN) 201410272665.8

(51) Int. Cl. C09K 5/14; C08K 3/38; C08K 9/04; C08K 3/34

(52) U.S. Cl. CPC C09K 5/14; C08K 3/34; C08K 3/38; C08K 9/04; C08K 2201/001; C08K 2201/005

(57) ABSTRACT

The present invention discloses a highly heat conductive boron nitride insulation material as well as preparation method and application thereof. The boron nitride insulation material provided by the present invention comprises aramid fiber, fibrid, mica, and granular boron nitride treated by polyphenylene sulfide. The highly heat conductive boron nitride fiber mica insulation material provided by the present invention has some characteristics, such as high heat conductivity, high insulativity, high strength, strong processability, as well as high physical property, high chemical resistance and the like, and is excellent in impact resistance, chemical corrosion resistance, heat fatigue resistance. Therefore, the insulation material can be applied to high-end insulation composite materials.

### TECHNICAL FIELD

The present invention relates to a highly heat conductive boron nitride insulation material as well as preparation method and application thereof.

### BACKGROUND

With the development of integration technology and assembly technology, the volume of electronic components and logic circuit becomes smaller and smaller, there is a need of highly heat conductive insulation material with good heat dissipation; with the rapid development of high-power electrical appliance, electronic products, etc., more and more heat generation problems inevitably occur. The heat generation, heat transfer and cooling during the operation process of large and medium scale high voltage generator and electromotor directly affect some important indicators such as work efficiency, service life, reliability and the like. As the application of high molecular material becomes more and more popular in various industrial applications, the requirements to the combination property thereof continuously improve. There is an urgent need of heat conductive insulation material in electronic and electrical material field to dissipate the large amount of heat generated in the integrated circuit, such that the electronic elements can work steadily at an appropriate temperature, so as to prolong the service life. When the heat conductive insulation material is used in the motor industry, the temperature rise of the machine winding can be effectively decreased, the volume of the motor is reduced and the power output is increased. Until now, there is not a high molecule material possessing both heat conductivity and insulating property, the studies at home or abroad all focus on blending certain heat conductive insulating inorganic filler to a high molecular material with a special requirement to obtain a highly heat conductive insulating complex material, but the effects is not significant. The novel heat dissipation insulation material has become one of the main directions of the modern motor technical study.

Now, the microelectronic integration technology and assembly technology are both developing rapidly, the assembling density is increasing rapidly, the volume of the electronic element and the logic circuit are diminishing by tens of thousands of times, the electronic instrument becomes thinner and shorter day by day, while the working frequency is increasing sharply, the semiconductor thermal environment is changing rapidly to the high temperature direction. At this time, the heat generated by the electronic device rapidly accumulates and increases, in order to make the electronic element still capable of working normally with high reliability at service environment temperature and ensure the operational reliability of the elements, heat dissipation capability timely become an important limiting factor that affects the service life thereof. Higher requirements have been proposed to the heat conductive material in the industrial production and science and technology development, besides heat conductivity, it is more desired for the material to have excellent combination property, such as lightweight, easy processing, impact resistance, chemical corrosion resistance, excellent heat fatigue resistance, excellent electrical insulating property, chemical stability, etc. The conventional heat conductive material, such metal and metallic oxide as well as other metallic material, already cannot meet the usage requirement for insulation and heat conduction in some special case, such as electromagnetic shielding, electronic information, the insulation and heat conduction of power tube, integrated package, heat pipe, integrated circuit, copper-clad plate that are widely used in thermal engineering measurement technology field, and cannot be used as heat conductive insulation material required by military equipment, aerospace electronic device, motor, communication, electrical device, and instrument. Therefore, there is an urgent need to develop a heat conductive insulating high molecular complex material having excellent reliability, high heat dissipation property and excellent combination property as thermal interface and encapsulation material to replace the conventional high molecular material. The heat of the thermal element is rapidly transferred to the heat dissipation device, so as to ensure the normal operation of the electronic device. Therefore, the highly heat conductive insulating high molecular complex material is an indispensable key critical link in heat dissipation design, and its study and develop possess significant meaning.

For insulation material, as it does not exist transportation of the electron flow, their heat conductivity is 500 to 1000 times lower than metal material, until now, there is not a high molecule material with both good heat conductivity and insulating property yet. Now, the insulating mode with high heat conductivity abroad is still blending type, i.e. blending a certain inorganic filler with both heat conductivity and insulating property to an insulation material with special requirement.

However, how to utilize various means to form a heat conductive network at the most extent and achieve a effectively heat conduction so as to obtain a highly heat conductive system, many investigators once proposed various models to predicate the heat conductivity of the heat conductive material filled in filler (power, particle, fiber, and so on) with different shape. It is considered that, in those filled polymer system, if the conductive block formed by the accumulation of all the filler particle and the conductive block of the polymer are in a line in the thermal current direction, the heat conductivity of the complex material is highest; if they are in a row, the heat conductivity of the complex material is lowest. Actually, in order to improve the heat conductivity of the material, it must cause the high conductive insulating filler to form a heat conductive network in the polymer, thereby to form a heat conductive channel. However, such an ideal distribution and arrangement cannot be achieved in the product process, considering from the whole design of the complex material is not only required, a molding processing technology but also is designed. There are many studies at home and abroad, but a molding technology is not achieved yet.

### THE DISCLOSURE OF THE INVENTION

The purpose of the present invention is to provide a highly heat conductive boron nitride insulation material and preparation method and application thereof.

The boron nitride insulation material provided by the present invention comprises aramid fiber, fibrid, mica and granular boron nitride that is treated by polyphenylene sulfide (PPS).

The above boron nitride insulation material can be merely constituted by the above components.

Wherein, the aramid fiber is poly(m-phenylene isophthalamide) fiber (which is referred as aramid 1313 fiber for short) or poly(p-phenylene terephthalamide) fiber (which is referred as aramid 1414 fiber for short);

The fineness of the aramid fiber is 1 to 2d, the length is 2 to 10 mm;

The fibrid is 1313 fibrid or 1414 fibrid;

The mica is a non-calcinated mica or a calcinated mica; wherein, the non-calcinated mica is phlogopite, mirrorstone or artificial crystal mica (calcinating the selected mica flake at high temperature to dehydrate a portion of the crystal water in mica structure, such that the mica flake swells along a direction perpendicular to the cleavage plane, the texture becomes soft);

The particle size of the mica is 20 to 120 meshes;

Since boron nitride belongs to a non-polar material and is difficult to infiltrate, if taking pure boron nitride as raw material to obtain boron nitride insulation material finished product, as the dispersity of boron nitride in water is worse, and cannot form a uniform distribution, the pure boron nitride must be treated by PPS prior to use.

The boron nitride treated by polyphenylene sulfide is prepared by a method comprising the following steps: blending boron nitride with a biphenyl solution of 1 to 5 percents by weight of polyphenylene sulfide in a ratio of 1:1 by weight for 1 to 10 minutes, filtrating and drying;

The heat conductivity of granular boron nitride treated by polyphenylene sulfide is 10 W/m·K, the particle size is 5-80 μm.

The mass ratio of aramid fiber, fibrid, mica and granular boron nitride treated by polyphenylene sulfide is 1-10: 2-20: 50-90: 5-30.

The method of preparing the above boron nitride insulation material provided by the present invention comprises the following steps:

1) after conducting beating treatment to aramid fiber in a water granulated device, and then conducting fibrillation treatment with a metal disc mill, the aramid fiber with fibrillation is obtained, the beating degree thereof is 50-80° SR;

2) after conducting the beating treatment to fibrid in the water granulated device, and then conducting the fibrillation treatment with a metal disc mill, the fibrid with fibrillation is obtained, the beating degree thereof is 50-80° SR;

3) after mixing the aramid fiber with fibrillation obtained in step 1), the fibrid with fibrillation obtained in step 2), mica, granular boron nitride treated by polyphenylene sulfide (PPS), and water evenly, dehydrating water, then the boron nitride insulation material is obtained.

In the above step 1), firstly conducting the beating treatment to aramid fiber, then applying mechanical force to aramid fiber via a disc mill, thereby to increase the specific area of aramid fiber, resulting that polar groups in the aramid molecule is more exposed, Zeta potential accordingly increases from 30 mV to 70 mV; in addition, after the above treatment, the dispersity of aramid fiber in the water suspension improves. After employing the above treatment to fibrid in step 2), the Zeta potential accordingly increases from −32 mV to 68 mV;

The beating degree of the fibrid with fibrillation obtained in step 2) particularly can be 60° SR;

In step 3), when aramid fiber is mixed with mica and heat conductive boron nitride material, the charge and Van der Waals' force generated by aramid fiber result in fiber having strong adsorption force to mica flake and heat conductive material, so that highly heat conductive material arranges uniformly between fiber and mica, and a network structure is formed.

The above method can be performed by conducting papermaking once to mold in the way of paper making through 1094 cylinder machine. Meanwhile, according to the customer requirement, conducting hot-pressing treatment to the paper surface, adjusting the pore, permeability and the thickness of paper. According to the requirement, different ratio can be employed so as to meet the manufacture process requirement of downstream products.

Additionally, electronic insulation material, microelectronic insulation material, electrical device or engine containing boron nitride insulation material provided by the present invention, and the application of this boron nitride insulation material in preparing electronic insulation material, microelectronic insulation material, electrical device or engine, also belong to the protection scope of the present invention.

Since the aramid fiber and heat conductive boron nitride material are non-polar materials, they are insoluble in water. The specific gravity of mica is large and it is easy to sink to the bottom. If mixing the aramid fiber, mica, fibrid and heat conductive boron nitride material directly, the dispersion is uneven. It must follow the method provided by the present invention, firstly conducting the zeta potential treatment to aramid fiber, and then conducting the fibrillation treatment through specific disc mill technology, such that the surface charge of aramid fiber increases, the specific area becomes larger, combined with the action of the Van der Waals' force, resulting in the heat conductive boron nitride material combining closely between the aramid fiber and mica, thus forming a heat conductive channel. The whole process flow employs a physical manner to treat without adding any chemicals, and all kinds of raw materials are dispersed in water without running away.

### THE DESCRIPTION OF FIGURES

FIG. 1 is cross-sectional electronic microscope photograph of boron nitride insulation material.

FIG. 2 is a comparative curve graph of the heat conductivity of boron nitride insulation material.

### BEST MODE FOR IMPLEMENTING THE INVENTION

The present invention will be further illustrated in combination with the particular examples, but the present invention is not limited to the following examples. The methods are all conventional methods unless otherwise specified. All the raw materials can be available in a disclosed commercial approach unless otherwise specified.

The purchase sources of various materials used in the following examples are as follows:

aramid 1313 fiber: produced by Xinhuicaiyan Incorporated Company, the fineness is 1 to 2d, the length is 2 to 10 mm;

aramid 1414 fiber: produced by Teijin Limited or Chenguang Chemical Research Institute, the fineness is 1 to 2d, the length is 2 to 10 mm;

1313 fibrid: produced by Xinhuicaiyan Incorporated Company;

1414 fibrid: produced by Teijin Limited;
mirrorstone: Weilaite Company of Ya'an, the particle size is 100 meshes;
boron nitride: TOSOH Corporation of Japan.

### Example 1

1) The Pretreatment of Boron Nitride:

Preparing 25 parts by weight of pure boron nitride into a whisker-like with a large specific surface area, then blending the boron nitride with a biphenyl solution of PPS with a mass percentage concentration of 2% in a mass ratio of 1:1 for 5 minutes, filtering and drying at high temperature, and obtaining a granular boron nitride with a heat conductivity of 10 W/m·K, and particle size of 5 to 80 μm;

2) after conducting the beating treatment to 5 parts by weight of aramid 1313 fiber in the water granulated device, then conducting the fibrillation treatment with a metal disc mill, the aramid fiber with fibrillation is obtained, and the beating degree thereof is 50° SR;

3) after conducting the beating treatment to 10 parts by weight of 1313 fibrid in the water granulated device, then conducting the fibrillation treatment with a rapidly rotating metal disc mill for 5 minutes, the fibrid with fibrillation is obtained, and the beating degree thereof is 60° SR;

TABLE 1
The comparative table of Zeta potential of aramid after the treatment

| Name | Before the treatment | After the treatment |
|---|---|---|
| the fibrid with fibrillation | −32 mV | 68 mV |
| obtained from step 3) | | |
| the aramid fiber with | 30 mV | 70 mV |
| fibrillation obtained | | |
| from step 2) | | |

4) delivering 5 parts by weight of the aramid fiber with fibrillation obtained from step 2), 10 parts by weight of the fibrid with fibrillation obtained from step 3), 60 parts by weight of mirrorstone, 25 parts by weight of the granular boron nitride obtained from step 1), and appropriate amount of deionized water into a tank for distributing slurry, then fully stirring with a strong agitator until each raw material disperses evenly.

Finally, the evenly dispersed slurry is flowed into a box for steadying slurry, adjusting the net valve on the box for steadying slurry, delivering to papermaking system through a drain channel, resulting that the slurry distributes evenly on the 1094 cylinder machine to conduct the molding operation. When the slurry run along the molded net, the excessive moisture is filtered out from the slurry under the pressure of the couch roll, the boron nitride insulation material provided by the present invention is obtained by curling once to mold after further dehydrating through driving embryo paper by a blanket via a high temperature drying cylinder.

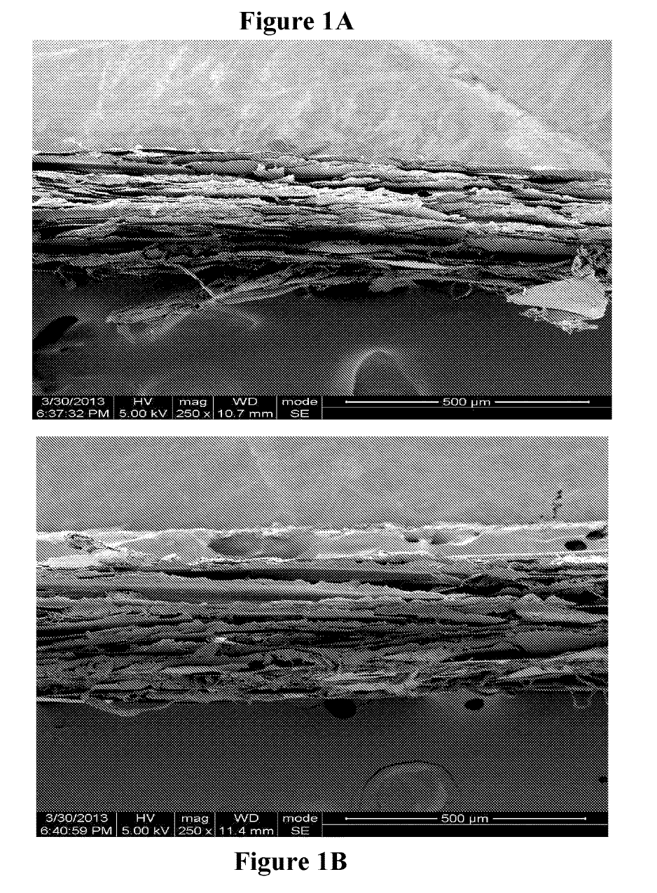

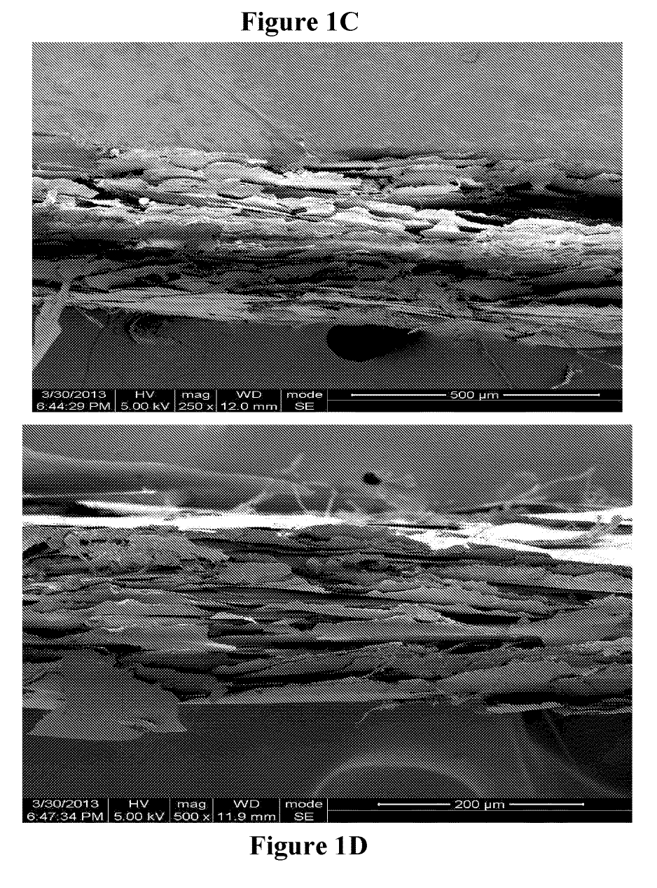

The cross-sectional electronic microscope photograph of the material is shown as FIG. 1.

It can be clearly seen from FIG. 1 that the cross-sectional structure is arranged in line, only arranging in line can achieve the best heat conductive effect, thereby to truly achieve the theoretical heat conductive channel.

The performance indicators of the material see Table 2.

TABLE 2
The performance test results of the boron nitride insulation material

| | item unit | test results | application standard |
|---|---|---|---|
| quantify | g/m² | 120 | 120 ± 6 |
| thickness | mm | 0.10 | 0.10 ± 0.01 |
| compressive strength | KV/mm | 18 | >13 |
| tensile strength | N/mm² | 6.5 | >5 |
| air permeability | S/100 ml | 92-108 | <600 |
| permeability | S | 19 | 15-40 |

It can be known from table 2 that, all the combination properties of boron nitride insulation material can meet the application standard. Its air permeability is much lower than the standard, which is in favor of accessing and dispersing for resin when soaked with the resin thereafter.

After soaking with epoxy resin, the heat conductivity of the boron nitride insulation material is tested, and the particular test method is as follows:

10 g of boron nitride insulation material obtained from the example is wrapped with a certain specification of glass fiber cloth, and soaking with 2 g of epoxy resin, curing at 150° C. for 0.5 hour, then obtaining the sample to be tested, and then testing the heat conductivity thereof with a heat conductivity tester.

The comparative material is a 120 g/m² mica paper from Weilaite Company of Ya'an.

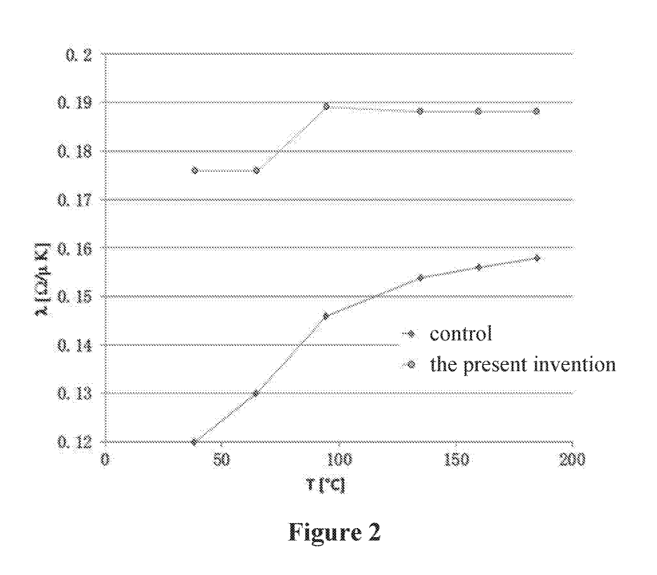

The results can be seen in FIG. 2.

It can be seen that, the addition of boron nitride greatly increases the heat conductive property of the material, it is fully demonstrated that the treatment to boron nitride is feasible, and the defect of poor wettability is solved.

### INDUSTRIAL APPLICATION

The highly heat conductive boron nitride fiber mica insulation material provided by the present invention has some characteristics, such high heat conductivity, high insulativity, high strength, strong processability, as well as high physical property, high chemical resistance and the like, and is excellent in impact resistance, chemical corrosion resistance, heat fatigue resistance, which can be applied to high-end insulation composite materials. Currently, the manufacture process of such highly heat conductive aramid fiber mica insulation material has not been reported at home and abroad. The insulation material reforms theory of conventional products with electrical and heat conductivity, electrical and heat insulation, while it really achieves heat conductive insulation and achieves the theoretic heat conductive channel, and it can be referred as an important revolution of insulation industry. Moreover, the product also accumulates various properties of aramid and mica, the processability of the product is good, it is a novel highly heat conductive insulating polymeric material, and can be widely used in various fields, such as high-end electron, microelectronic integration field, as well as various large electrical device, engine, civil or other special use and the like.

1. A boron nitride insulation material comprising aramid fiber, fibrid, mica and granular boron nitride treated by polyphenylene sulfide.

2. The insulation material according to claim 1, wherein the boron nitride insulation material is constituted by aramid fiber, fibrid, mica and boron nitride treated by polyphenylene sulfide.

3. The insulation material according to claim 2, wherein the aramid fiber is poly(m-phenylene isophthalamide) fiber or poly(p-phenylene terephthalamide) fiber;
the fineness of the aramid fiber is 1 to 2d, the length is 2 to 10 mm;
the fibrid is 1313 fibrid or 1414 fibrid;
the mica is a non-calcinated mica or a calcinated mica; wherein, the non-calcinated mica is phlogopite, mirrorstone or artificial crystal mica;
the particle size of the mica is 20 to 120 meshes;
the boron nitride treated by polyphenylene sulfide is prepared by a method comprising the following steps: blending boron nitride with a biphenyl solution of 1 to 5 percent by weight of polyphenylene sulfide in a ratio of 1:1 by weight for 1 to 10 minutes, filtrating and drying; and
the heat conductivity of granular boron nitride treated by polyphenylene sulfide is 10 W/m·K, the particle size is 5-80 μm.

4. The insulation material according to claim 3, wherein the mass ratio of the aramid fiber, fibrid, mica and granular boron nitride treated by polyphenylene sulfide is 1-10:2-20:50-90:5-30.

5. A method for preparing a boron nitride insulation material including aramid fiber, fibrid, mica and granular boron nitride treated by polyphenylene sulfide, the method comprising the following steps:
1) after conducting beating treatment to the aramid fiber in a water granulated device, conducting fibrillation treatment with a metal disc mill, the aramid fiber with fibrillation is obtained, the beating degree thereof is 50-80° SR;
2) after conducting the beating treatment to the fibrid in the water granulated device, conducting the fibrillation treatment with a metal disc mill, the fibrid with fibrillation is obtained, the beating degree thereof is 50-80° SR; and
3) after mixing the aramid fiber with fibrillation obtained in step 1), the fibrid with fibrillation obtained in step 2), the mica, the granular boron nitride treated by polyphenylene sulfide, and water evenly, dehydrating water, then the boron nitride insulation material is obtained.

6. An electronic insulation material, microelectronic insulation material, electrical device or engine comprising the boron nitride insulation material including aramid fiber, fibrid, mica and granular boron nitride treated by polyphenylene sulfide.

7. (canceled)
